(19) United States
(12) Patent Application Publication
(10) Pub. No.: US 2007/0171678 A1
(43) Pub. Date: Jul. 26, 2007

(54) Light guiding unit and backlight assembly having the same

(76) Inventors: Sung-Kyu Shim, Seoul (KR); In-Sun Hwang, Gyeonggi-do (KR); Seong-Yong Hwang, Gyeonggi-do (KR); Joo-Woan Cho, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/656,916

(22) Filed: Jan. 22, 2007

(30) Foreign Application Priority Data
Jan. 23, 2006 (KR) 2006-6718

(51) Int. Cl. F21V 7/04

(52) U.S. Cl. 362/616; 362/606; 362/617

(57) ABSTRACT

A light guiding unit that is capable of reducing the thickness of a backlight assembly and operating with fewer light sources is presented. The light guiding unit includes a first surface, a second surface and a light incident surface. The first surface includes a light exiting surface and an upper guiding curved surface that is recessed with respect to the light exiting surface. The second surface includes an opposite surface that is substantially parallel to the light exiting surface and a lower guiding curved surface recessed on the opposite surface toward the first surface, the lower guiding curved surface being positioned along the upper guiding curved surface. The light incident surface is formed on an end portion of the lower guiding curved surface.

### CROSS-REFERENCE TO RELATED APPLICATIONS

The present application claims priority from Korean Patent Application No. 2006-06718 filed on Jan. 23, 2006, the disclosure of which is incorporated herein by reference in its entirety.

### BACKGROUND OF THE INVENTION

1. Field of the Invention

The present invention relates to a light guiding unit and a backlight assembly having the light guiding unit. More particularly, the present invention relates to a light guiding unit for a direct illumination type backlight assembly having a light emitting diode and a backlight assembly that uses the light guiding unit.

2. Description of the Related Art

A liquid crystal display (LCD) device, in general, is used in personal computers, laptop computers, automobile navigation systems, television receiver sets, etc., to convert information in electrical signals into visual images. The LCD device has advantageous characteristics such as light weight, thinness, low driving voltage requirement, etc., that explain its wide usage in various fields.

A backlight assembly of the LCD device is classified into a direct illumination type backlight assembly and an edge illumination type backlight assembly based on the location of the light source. The direct illumination type backlight assembly includes a plurality of light sources under a display panel. The edge illumination type backlight assembly includes a light source along a side surface of a light guiding plate to supply the display panel with light.

The light source of the backlight assembly includes a cold cathode fluorescent lamp, a light emitting diode (LED), etc. The light emitting diode has various characteristics such as low power consumption, small volume, light weight, etc.

An edge illumination type backlight assembly has advantages. For example, when an edge illumination type backlight assembly includes the light emitting diode, color reproducibility and luminance uniformity of the light exiting the backlight assembly improve and the backlight assembly is made thinner.

However, many of these advantages do not apply when the screen size exceeds a critical size. For example, when light emitting diodes are on the side surface of a large screen display device, the light from the light emitting diodes is not uniformly distributed in the light guiding plate, at least in part because there is a special limitation as to the number of light emitting diodes that can be included. In addition, the thickness of the light guiding plate increases when the screen size becomes large, also increasing the weight of the screen display device.

A direct-illumination type backlight assembly has its advantages, too. When a direct illumination type backlight assembly includes the light emitting diode, the light guiding plate can be omitted so that the backlight assembly is lighter. In addition, the direct illumination type backlight assembly can accommodate more light emitting diodes than the edge-illumination type backlight assembly so that a larger screen can be illuminated properly.

However, the direct-illumination type backlight assembly is not without its disadvantages. In the direct illumination type backlight assembly, red light, green light and blue light that from the light emitting diodes are mixed at a predetermined distance away from the light emitting diodes to form white light. For this reason, the thickness of the direct illumination type backlight assembly is increased. In addition, the number of the light emitting diodes is greatly increased.

### SUMMARY OF THE INVENTION

The present invention provides a light guiding unit for a direct illumination type backlight assembly having a light emitting diode.

The present invention also provides a backlight assembly having the above-mentioned light guiding unit.

In one aspect, the invention is a light guiding unit that includes a first surface, a second surface and a light incident surface. The first surface includes a light exiting surface and an upper guiding curved surface recessed with respect to the light exiting surface. The second surface includes an opposite surface that is substantially parallel to the light exiting surface and a lower guiding curved surface recessed on the opposite surface toward the first surface, the lower guiding curved surface being positioned along the upper guiding curved surface. The light incident surface is formed on an end portion of the lower guiding curved surface.

In another aspect, the invention is a backlight assembly that includes the above light guiding unit and a light source.

The backlight assembly may further include a plurality of light incident surfaces having rod shapes arranged substantially parallel with each other, and the light source may include a plurality of light emitting diodes arranged on the light incident surfaces in a longitudinal direction of the light incident surfaces. The light guiding unit may guide the red, green and blue lights so that white light is emitted from the light exiting surface.

In still another aspect, the invention is a backlight assembly that includes a light source and a light guiding unit. The light source generates light. The light guiding unit is optically coupled to the light source, and has a substantially plate shape including a protruded portion that is protruded toward the light source.

According to the present invention, the number of the point light sources is decreased in the direct illumination type backlight assembly. In addition, luminance uniformity is increased, and thickness of the backlight assembly is decreased.

### BRIEF DESCRIPTION OF THE DRAWINGS

The above and other advantages of the present invention will become more apparent by describing in detail example embodiments thereof with reference to the accompanying drawings, in which:

FIG. 1 is a perspective view illustrating a light guiding unit in accordance with one embodiment of the present invention;

FIG. 2 is a cross-sectional view taken along the line I-I′ shown in FIG. 1;

FIG. 3 is a perspective view illustrating a light guiding unit in accordance with another embodiment of the present invention;

FIG. 4 is a perspective view illustrating the lower surface of the light guiding unit shown in FIG. 3;

FIG. 5 is a cross-sectional view taken along the line II-II′ shown in FIG. 3;

FIG. 6 is a perspective view illustrating a light guiding unit in accordance with another embodiment of the present invention;

FIG. 7 is a perspective view illustrating a light guiding unit in accordance with another embodiment of the present invention;

FIG. 8 is a perspective view illustrating a light guiding unit in accordance with another embodiment of the present invention;

FIG. 9 is a perspective view illustrating the lower surface of the light guiding unit shown in FIG. 8;

FIG. 10 is a cross-sectional view taken along the line III-III′ shown in FIG. 8;

FIG. 11 is a perspective view illustrating the lower surface of a backlight assembly in accordance with another embodiment of the present invention;

FIG. 12 is a cross-sectional view taken along the line IV-IV′ shown in FIG. 11;

FIG. 13 is an enlarged cross-sectional view illustrating the backlight assembly shown in FIG. 12;

FIG. 14 is a cross-sectional view taken along the line V-V′ shown in FIG. 11;

FIG. 15 is a cross-sectional view illustrating a backlight assembly in accordance with another embodiment of the present invention;

FIG. 16 is a perspective view illustrating a lower surface of a backlight assembly in accordance with another embodiment of the present invention;

FIG. 17 is a cross-sectional view taken along the line VI-VI′ shown in FIG. 16;

FIG. 18 is a cross-sectional view illustrating a backlight assembly in accordance with another embodiment of the present invention;

FIG. 19 is a perspective view illustrating a display device in accordance with another embodiment of the present invention;

FIG. 20 is an exploded perspective view illustrating the display device shown in FIG. 19;

FIG. 21 is a cross-sectional view taken along the line VII-VII′ shown in FIG. 20; and

FIG. 22 is an exploded perspective view illustrating a display device in accordance with another embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

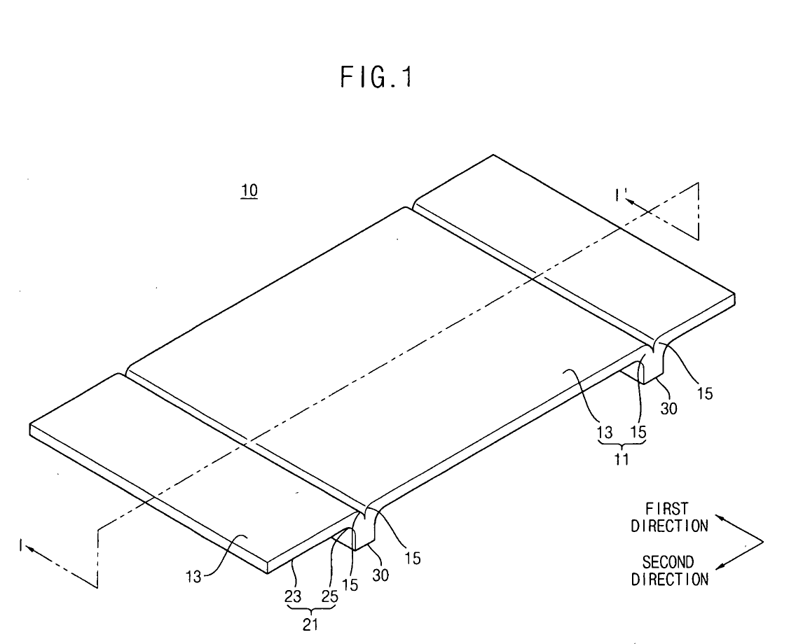

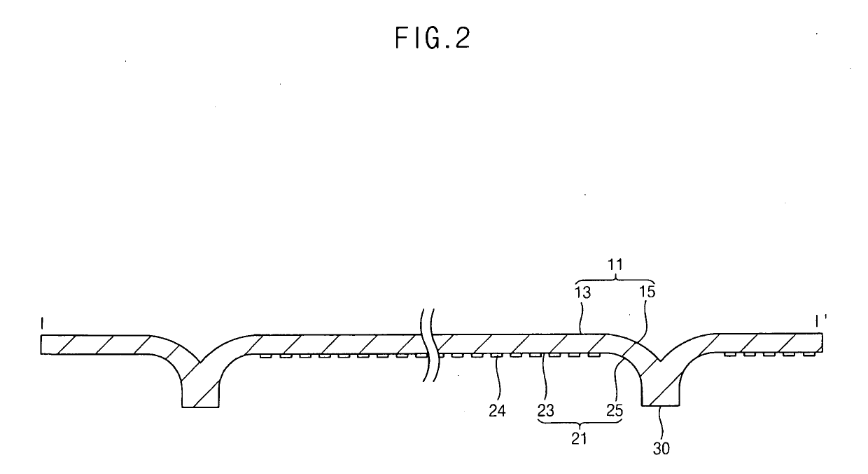

FIG. 1 is a perspective view illustrating a light guiding unit in accordance with one embodiment of the present invention. FIG. 2 is a cross-sectional view taken along the line I-I′ shown in FIG. 1.

Referring to FIGS. 1 and 2, the light guiding unit 10 of a direct illumination type backlight assembly guides light generated from a point light source arranged on a direct illumination portion of a display panel toward the display panel. Thus, luminance uniformity of the light incident on the display panel is improved. The light guiding unit 10 may be part of a display device.

The light guiding unit 10 includes a light dispersing material having desired characteristics in terms of light transmittance, heat resistance, chemical resistance, mechanical strength, etc. Examples of the light dispersing material that can be used for the light guiding unit 10 include polymethylmethacrylate, polyamide, polyimide, polypropylene, and polyurethane, among others.

In FIGS. 1 and 2, the light guiding unit 10 has a substantially plate shape including a recessed portion that is recessed toward the point light source and a protruded portion that is protruded toward the point light source. The protruded portion may have substantially the same profile as the recessed portion. The recessed and the protruded portions may be on a lower surface and an upper surface of the light guiding unit 10, respectively.

For example, the light guiding unit 10 includes a first surface 11, a second surface 21 and a light incident surface 30.

The first surface 11 is an upper surface of the light guiding unit 10, and includes a light exiting surface 13 and an upper guiding curved surface 15. For example, the light exiting surface 13 may have a substantially rectangular shape with a long side and a short side, and may be substantially flat. The upper guiding curved surface 15 extends in a first direction that is substantially parallel to the short side of the light exiting surface 13, and may be recessed generally in a direction that is orthogonal to the light exiting surface 13.

As shown in FIG. 2, the upper guiding curved surface 15 may have an inverted-U shaped cross-section. The upper guiding curved surface 15 is recessed from the light exiting surface 13 so that the upper guiding curved surface 15 includes a left upper guiding curved surface and a right upper guiding curved surface that are arranged substantially symmetrically. End portions of the left and right upper guiding curved surfaces are rounded and connected to each other to form the bottom of the recess.

The upper guiding curved surface 15 is bent to a first curvature. The first curvature may be a variable curvature like that of an ellipsoid. Alternatively, the first curvature may be a uniform curvature like that of a sphere. The upper guiding curved surface 15 forms the recessed portion of the light guiding unit 10.

The second guiding curved surface 21 is a lower surface of the light guiding unit 10, and includes an opposite surface 23 and a lower guiding curved surface 25. The opposite surface 23 faces the light exiting surface 13 so that the light guiding unit 10 has a predetermined thickness. In FIG. 2, a plurality of patterns 24 (e.g., circular patterns) is formed on the opposite surface 23. The patterns 24 are randomly distributed on the opposite surface 23. The lower guiding curved surface 25 extends in the first direction, and curves on the opposite surface 23 along the upper guiding curved surface 15.

The lower guiding curved surface 25 includes a left lower guiding curved surface and a right lower guiding curved surface that are arranged substantially symmetrically. End portions of the right and left lower guiding curved surfaces are spaced apart from each other by a predetermined distance.

The lower guiding curved surface 25 is bent to have a second curvature. The second curvature may be a variable curvature like that of an ellipsoid. Alternatively, the second curvature may be a uniform curvature like that of a sphere.

In FIGS. 1 and 2, the second curvature of the lower guiding curved surface 25 is greater than the first curvature of the upper guiding curved surface 15. For example, when a distance from a boundary between the right and left lower guiding curved surfaces is decreased along the upper guiding curved surface 15 or the lower guiding curved surface 25, a thickness of the light guiding unit 10 is increased. The thickness is a distance between the upper guiding curved surface 15 and the lower guiding curved surface 25.

The light incident surface 30 extends in the first direction that is substantially parallel to the direction in which the upper guiding curved surface 15 and the lower guiding curved surface 25 extend. For example, the light incident surface 30 is substantially parallel to the light exit surface 13 and the opposite surface 23. A long side of the light incident surface 30 is connected to the end portion of the lower guiding curved surface 25, and the end portion of the upper guiding curved surface 15 is spaced apart from the light incident surface 30 by a predetermined distance. This predetermined distance may be measured along an imaginary straight line that extends from the bottom of the recess to the center of the light incident surface 30.

In FIGS. 1 and 2, the light guiding unit 10 includes two light incident surfaces 30. The light incident surfaces 30 are substantially parallel to each other, and are separated along a second direction that is substantially perpendicular to the first direction. The second direction is substantially parallel to the long side. The lower guiding curved surface 25 and the light incident surface 30 form the protruded portion of the light guiding unit 10.

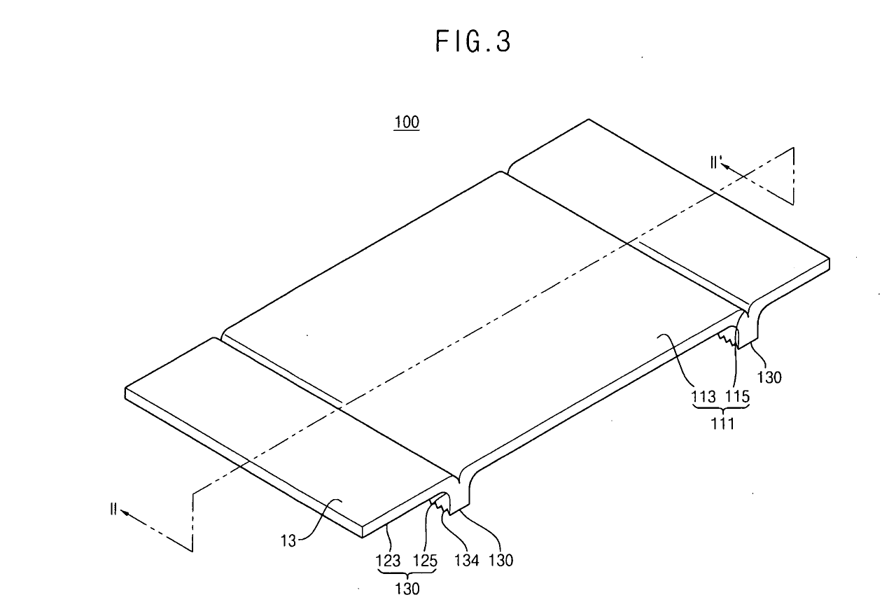

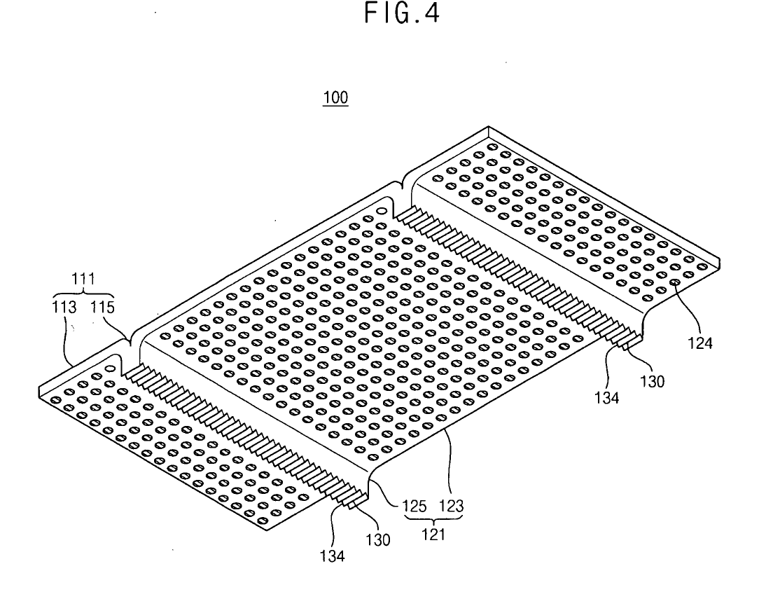

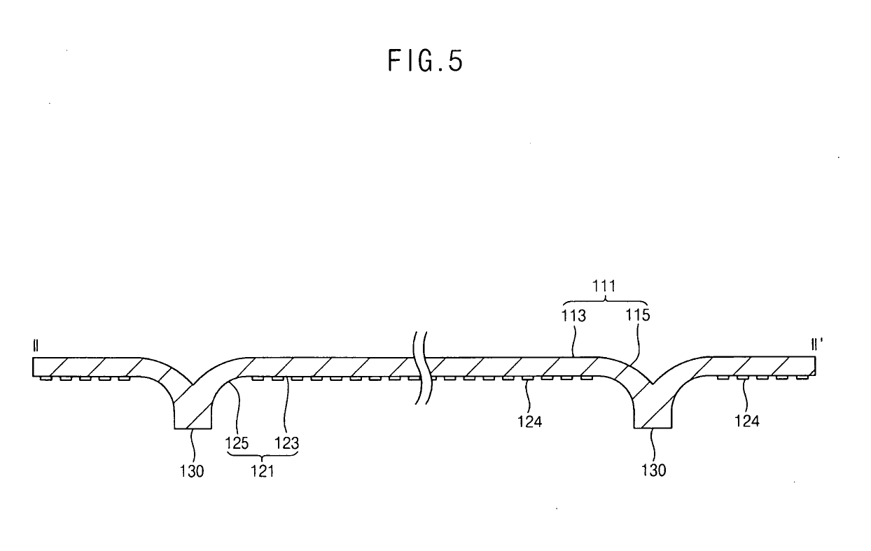

FIG. 3 is a perspective view illustrating a light guiding unit in accordance with another embodiment of the present invention. FIG. 4 is a perspective view illustrating the lower surface of the light guiding unit shown in FIG. 3. FIG. 5 is a cross-sectional view taken along the line II-II′ shown in FIG. 3.

Referring to FIGS. 3 to 5, the light guiding unit 100 includes a first surface 111, a second surface 121 and a light incident surface 130. The light guiding unit 100 of FIGS. 3 to 5 is the same as the embodiment shown in FIGS. 1 and 2 except for the second surface 121 and the light incident surface 130. Thus, the same reference numerals will be used to refer to the same or like parts as those described in FIGS. 1 and 2 and any redundant explanation concerning the above elements will be omitted.

The light incident surface 130 of FIGS. 3 to 5 is the same as the light incident surface 30 shown in FIGS. 1 and 2 except for a first optical pattern. The first optical pattern includes a plurality of first prisms 134 formed on the light incident surface 130, and the first prisms 134 extend in a second direction (shown in FIG. 1). The first prisms 134 diffuse light in a first direction (shown in FIG. 1) that is substantially perpendicular to the second direction. Thus, light is incident on the light guiding unit 100 by impinging on the light incident surface 130, and is then guided in the second direction to be diffused in the first direction.

The second surface 121 of FIGS. 3 to 5 is the same as the second surface 21 shown in FIGS. 1 and 2 except for a second optical pattern formed on an opposite surface 123. The second optical pattern diffuses the guided light to improve color uniformity of the light that exits the light exiting surface 113 of the first surface 111.

For example, the second optical pattern includes a plurality of patterns 124, and a plurality of second prisms that extend in the first direction is formed on the patterns 124. In FIGS. 3 to 5, the second optical pattern is formed on the opposite surface to change the path of the guided light. The density of the patterns 124 decreases as the patterns 124 get closer to the lower guiding curved surface 125. Conversely, the density of the pattern 124 increases as the patterns 124 get farther away from the lower guiding curved surface 125.

The upper guiding curved surface 115 and the lower guiding curved surface 125 guide the light in the second direction. The patterns 124 randomly diffuse the guided light. The second prisms guide the light in the second direction to increase the luminance when viewed on a plane. The second optical pattern diffuses the light in the first direction and increases the luminance in the second direction.

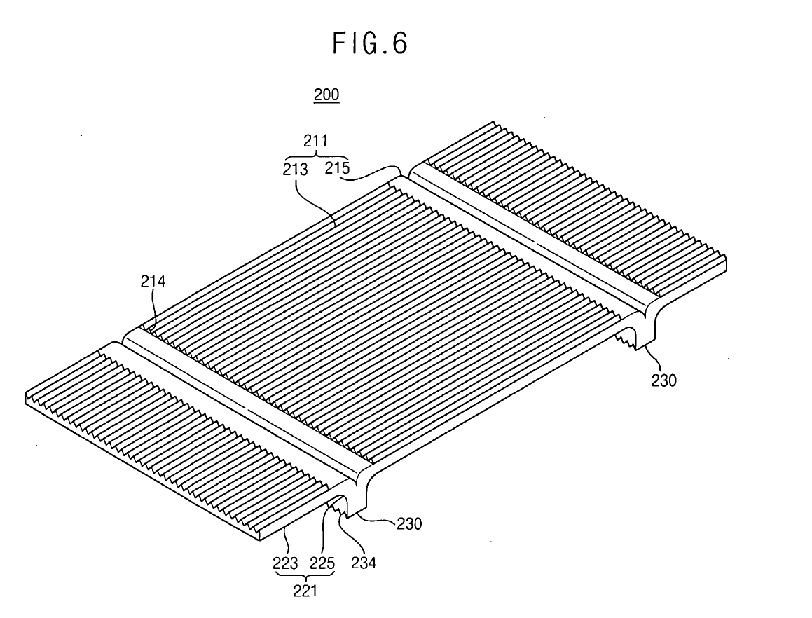

FIG. 6 is a perspective view illustrating a light guiding unit in accordance with another embodiment of the present invention.

Referring to FIG. 6, the light guiding unit 200 includes a first surface 211, a second surface 221 and a light incident surface 230. The light guiding unit 200 of FIG. 6 is the same as in FIGS. 3 to 5 except for the first surface 211. Thus, any redundant explanation concerning the above elements will be omitted.

The first surface 211 includes a light exiting surface 213 and an upper guiding curved surface 215. The first surface 211 of FIG. 6 is the same as the first surface 111 shown in FIGS. 3 to 5 except for a third optical pattern on the light exiting surface 213. Thus, any further explanation concerning the above elements will be omitted.

A first optical pattern 234 formed on the light incident surface 230 and a second optical pattern formed on an opposite surface 223 diffuse light in a first direction (shown in FIG. 1). Thus, the light from the light exiting surface 213 is inclined in the first direction with respect to an imaginary line that is substantially orthogonal to the light exiting surface 213. The third optical pattern guides the light from the light exiting surface 213 toward the normal direction. The third optical pattern includes a plurality of third prisms 214 that extend in a second direction (shown in FIG. 1).

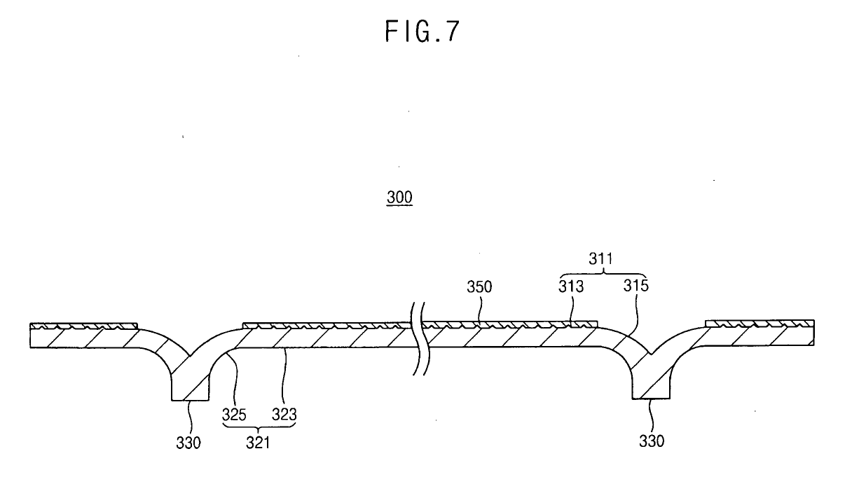

FIG. 7 is a perspective view illustrating a light guiding unit in accordance with another embodiment of the present invention.

Referring to FIG. 7, the light guiding unit 300 includes a first surface 311, a second surface 321, a light incident surface 330 and a liquid crystal film 350. The light guiding unit 300 of FIG. 7 is the same as the light guiding unit 100 shown in FIGS. 3 to 5 except for prisms of a light exiting surface 313 and the liquid crystal film 350. Thus, any redundant explanation concerning the above elements will be omitted.

The liquid crystal film 350 includes protecting films and a liquid crystal layer. The protecting films face each other, and the liquid crystal layer is interposed between the protecting films. For example, the liquid crystal layer includes cholesteric liquid crystals. Refractive index and reflectivity of the cholesteric liquid crystals are changed based on the vibration direction of the light incident on the cholesteric liquid crystals. Thus, the light exiting the light exiting surface 313 is polarized by the liquid crystal film 350.

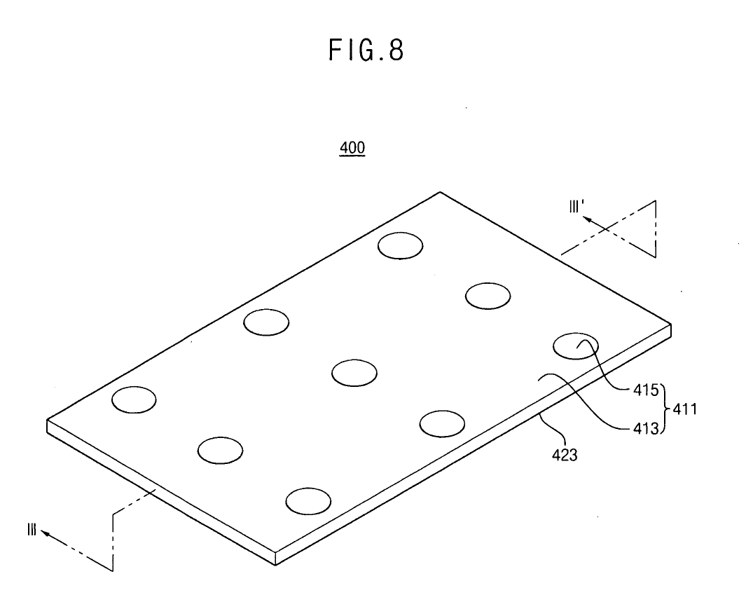

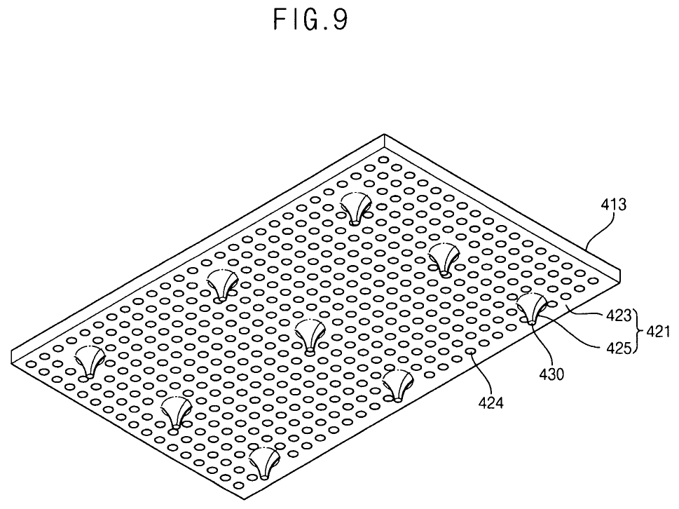

FIG. 8 is a perspective view illustrating a light guiding unit in accordance with another embodiment of the present invention. FIG. 9 is a perspective view illustrating the lower surface of the light guiding unit shown in FIG. 8.

Referring to FIGS. 8 and 9, the light guiding unit 400 includes a first surface 411, a second surface 421 and a light incident surface 430.

The first surface 411 is an upper surface of the light guiding unit 400, and includes a light exiting surface 413 and an upper guiding curved surface 415. For example, the upper guiding curved surface 415 may have a substantially conical shape. The light exiting surface 413 is substantially flat, and substantially rectangular in shape. Guiding regions are defined in on the surface of the light exiting surface 413, and the upper guiding curved surface 415 is part of a guiding region. The guiding regions are spaced apart from each other. In one embodiment, each of the guiding regions has a substantially circular shape, and the guiding regions are arranged in a matrix shape.

The light exiting surface 413 is a region in the rectangular surface excluding the guiding regions. The guiding regions are recessed into the planar surface, generally in a direction that is substantially orthogonal to the light exiting surface 413. The upper guiding curved surface 415 is formed in the guiding regions that are recessed. The apex of the upper guiding curved surface 415 may be rounded.

The upper guiding curved surface 415 is bent to have a first curvature. For example, the first curvature may be a variable curvature like that of an ellipsoid. Alternatively, the first curvature may be a uniform curvature like that of a sphere.

The second surface 421 includes an opposite surface 423 and a lower guiding curved surface 425. The opposite surface 423 is from the other side of the light exiting surface 413 wherein the light guiding unit 400 has a predetermined thickness. The lower guiding curved surface 425 extends from the opposite surface 423 in a shape that tracks the upper guiding curved surface 415. A side of the lower guiding curved surface 425 forms a closed loop such as a circle.

The lower guiding curved surface 425 is bent to have a second curvature. In some embodiments, the second curvature may be a variable curvature like that of an ellipsoid. Alternatively, the second curvature may be a uniform curvature like that of a sphere.

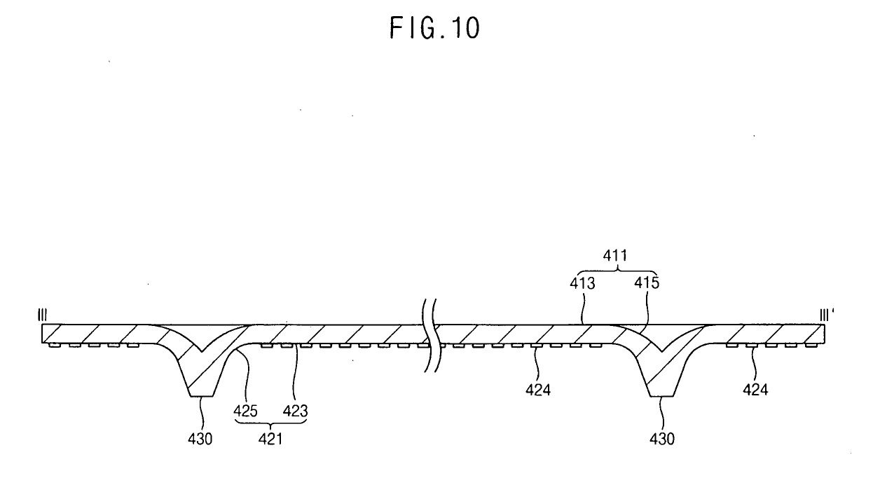

FIG. 10 is a cross-sectional view taken along the line III-III′ shown in FIG. 8.

Referring to FIG. 10, the second curvature of the lower guiding curved surface 425 is greater than the first curvature of the upper guiding curved surface 415. For example, when a distance from the center of each of the guiding regions is decreased along the upper guiding curved surface 415 or the lower guiding curved surface 425, the light guiding unit 400 becomes thicker. The “thickness” is a distance between the upper guiding curved surface 415 and the lower guiding curved surface 425.

End portions of the light incident surface 430 are connected to the lower guiding curved surfaces 425. Thus, the light incident surface 430 may have a circular shape when viewed from the bottom. A plurality of light incident surfaces 430 corresponding to the guiding regions are arranged as “islands” in a matrix configuration.

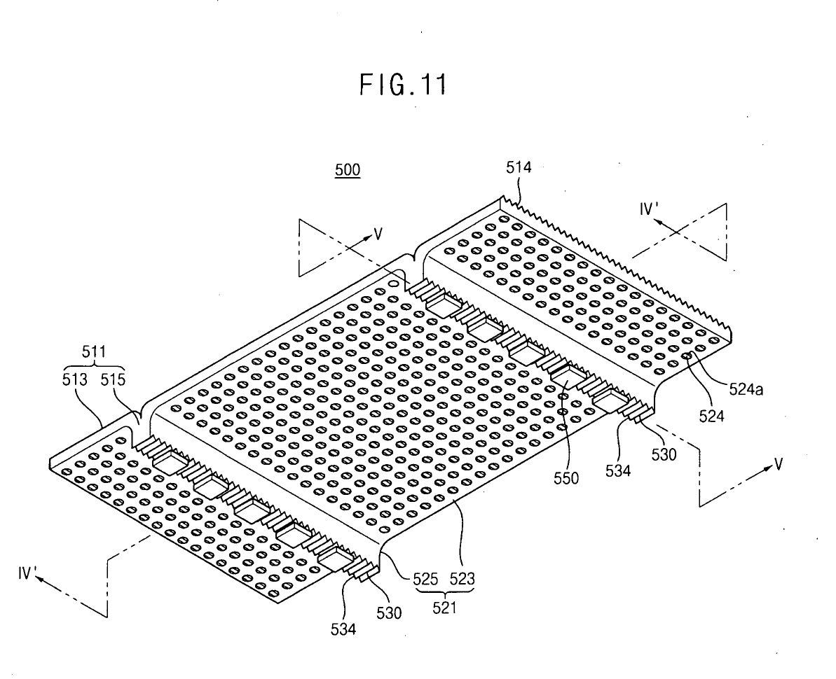

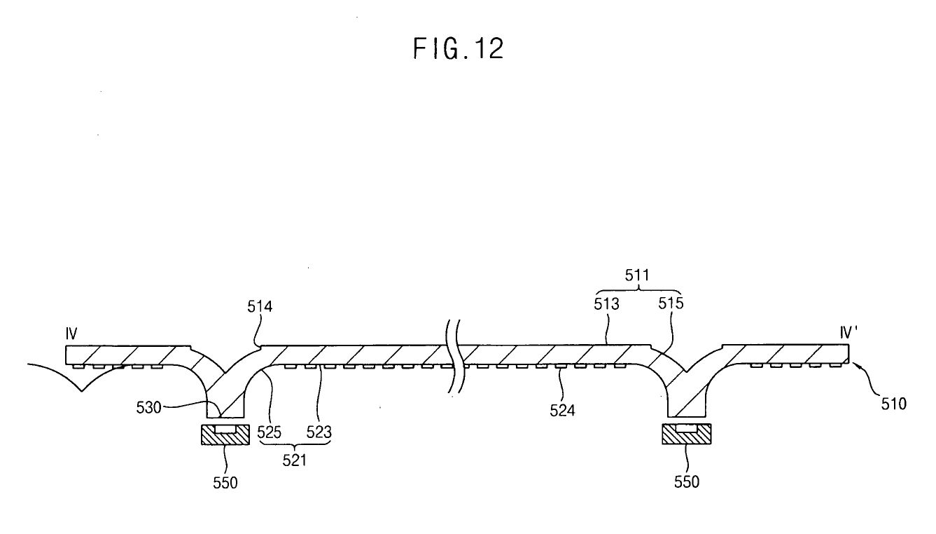

FIG. 11 is a perspective view illustrating the lower surface of a backlight assembly in accordance with another embodiment of the present invention. FIG. 12 is a cross-sectional view taken along the line IV-IV′ shown in FIG. 11.

Referring to FIGS. 11 and 12, the backlight assembly 500 includes a light guiding unit 510 and a light source 550.

The light guiding unit 510 includes a first surface 511, a second surface 521 and a light incident surface 530. The light guiding unit 500 of FIGS. 11 and 12 is substantially the same as the light guiding unit 200 shown in FIG. 6. Thus, any redundant explanation concerning the above elements will be omitted.

A plurality of first prisms 534 is formed on the light incident surface 530 as a first optical pattern. A plurality of patterns 524, which may be circular patterns, is formed on an opposite surface 523 of the second surface 521 as a second optical pattern. A plurality of second prisms 524a that extend in a first direction (shown in FIG. 1) is formed on the patterns 524. A plurality of third prisms 514 that extend in a second direction (shown in FIG. 1) is formed on a light exiting surface 513 of the first surface 511 as a third optical pattern.

A plurality of light sources is aligned on the light incident surface 530 that extends in the first direction. For example, the light sources are point light sources such as light emitting diodes 550. The light emitting diodes 550 include a red light emitting part, a green light emitting part and a blue light emitting part. The light emitting diodes 550 generate red light, green light and blue light, and the red, green and blue lights are incident on the light incident surface 530. The red, green and blue lights may be simultaneously incident on the light incident surface 530.

Alternatively, the light sources may include a red light emitting diode generating the red light, a green light emitting diode generating the green light and a blue light emitting diode generating the blue light. The red, green and blue light emitting diodes are arranged on the light incident surface 530.

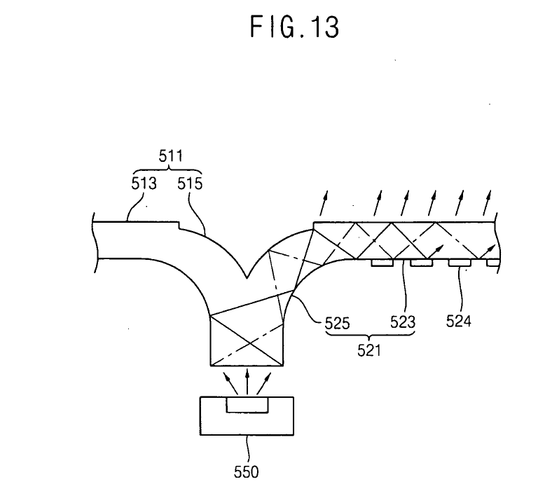

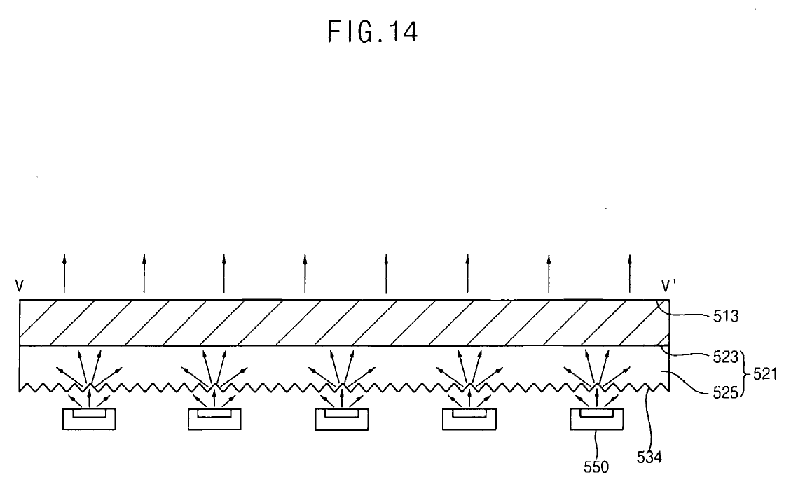

FIG. 13 is an enlarged cross-sectional view illustrating the backlight assembly shown in FIG. 12. FIG. 14 is a cross-sectional view taken along the line V-V′ shown in FIG. 11.

Referring to FIG. 13, an air layer is interposed between the light emitting diodes 550 and the light incident surface 530. The red light, the green light and the blue light generated from the light emitting diodes 550 pass through the air layer before reaching the light incident surface 530. The red light, the green light and the blue light are refracted on the light incident surface 530, and are guided between an upper guiding curved surface 515 and a lower guiding curved surface 525.

An exiting angle of the light generated from the light emitting diodes 550 is about ±70 degrees. The exiting angle of the red, green and blue lights that are refracted upon crossing the light incident surface 530 is about ±42.5 degrees with respect to a normal line that is substantially orthogonal to the light incident surface 530. A curvature of the upper guiding curved surface 515 and the lower guiding curved surface 525 may be a variable curvature like that of an ellipsoid. Alternatively, the curvature of the upper guiding curved surface 515 and the lower guiding curved surface 525 may be a uniform curvature like that of a sphere. The lower guiding curved surface 525 may be greater than the upper guiding curved surface 515.

Referring to FIG. 14, the red, green and blue lights generated from the light emitting diodes 550 may be guided in the upward direction. When the red, green and blue lights generated from the light emitting diodes 550 are guided in a predetermined direction, the red, green and blue lights are not mixed so that color uniformity of the white light formed by mixing the red, green and blue lights may be deteriorated.

In FIG. 14, the first prisms 534 diffuse the red, green and blue lights that are incident on the light guiding unit 500 through the light incident surface 530 in the first direction. Thus, the red, green and blue lights are mixed to increase the color uniformity of the ultimately-resulting white light.

The red, green and blue lights are diffused in the first direction so that the red, green and blue lights are mixed to form the white light. Substantially all of the white light is reflected by the upper guiding curved surface 515 and the lower guiding curved surface 525 through total internal reflection so that the white light is guided between the light exiting surface 513 and the opposite surface 523. In FIG. 14, a majority of the white light that is irradiated onto the upper guiding curved surface 515 may be reflected from the upper guiding curved surface 515. As for the remaining portion of the white light that is irradiated onto the upper guiding curved surface 515, it may pass through the upper guiding curved surface 515.

The guided white light is repetitively reflected and diffused between the light exiting surface 513 and the opposite surface 523, and is irregularly reflected from the patterns 524 formed on the opposite surface 523. The second prisms formed on the patterns 524 guide the white light reflected by the opposite surface 523 in the second direction and reflects the white light in the first direction.

When the white light having an incident angle of less than a critical angle is irradiated onto the light exiting surface 513, the white light exits the light exiting surface 513. The third prisms 514 (shown in FIG. 11) formed on the light exiting surface 513 further guide the light that is guided in the first direction in a direction that is substantially orthogonal to the light exiting surface 513. Thus, luminance uniformity of the white light on the first surface 511 and luminance when viewed on the first surface 511 are increased.

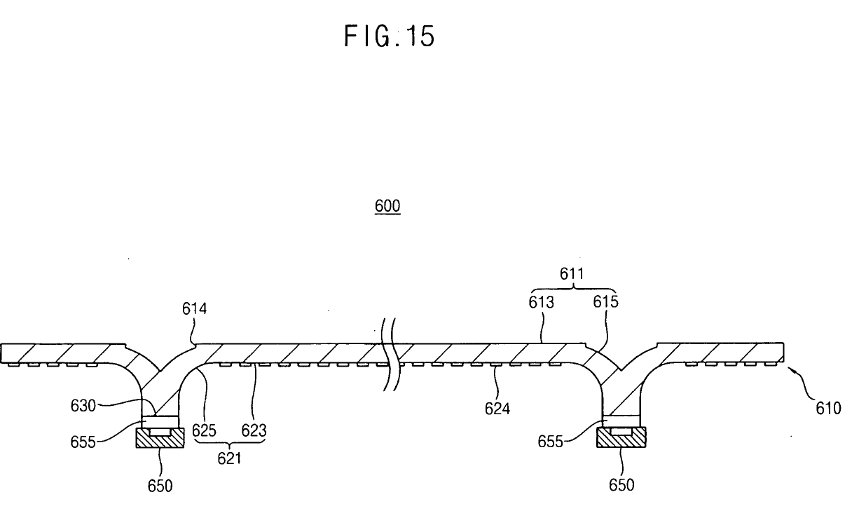

FIG. 15 is a cross-sectional view illustrating a backlight assembly in accordance with another embodiment of the present invention.

Referring to FIG. 15, the backlight assembly 600 includes a light guiding unit 610, a light emitting diode 650 and a connecting member 655. The backlight assembly 600 of FIG. 15 is the same as the backlight assembly 500 shown in FIGS. 11 to 14 except for the connecting member. Thus, any redundant explanation concerning the above-described elements will be omitted.

The connecting member 655 includes a transparent material such as silicone, and is interposed between the light emitting diode 650 and a light incident surface 630. Thus, there is no air layer between the light incident surface 630 and the light emitting diode 650. Without the air layer, impurities are not interposed between a light emitting portion of the light emitting diode 650 and the light incident surface 630, and the light incident surface 630 is not colored, thereby improving the luminance of the light generated from the light emitting diode 650.

The refractive index of the connecting member 655 may be smaller than that of the light guiding unit 610 and greater than that of the air layer. Thus, red, green and blue lights generated from the light emitting diode 650 are guided in a direction that is substantially orthogonal to the light exiting surface 613 on the light incident surface 630 that is an interface between the connecting member 655 and the light guiding unit 610. Therefore, the exiting angle of the refracted red, green and blue lights that at the light incident surface 630 is smaller than the exiting angle of the light generated from the light emitting diode 650 so that a majority of the refracted red, green and blue lights reflects off the upper guiding curved surface 615 and the lower guiding curved surface 625 through total internal reflection.

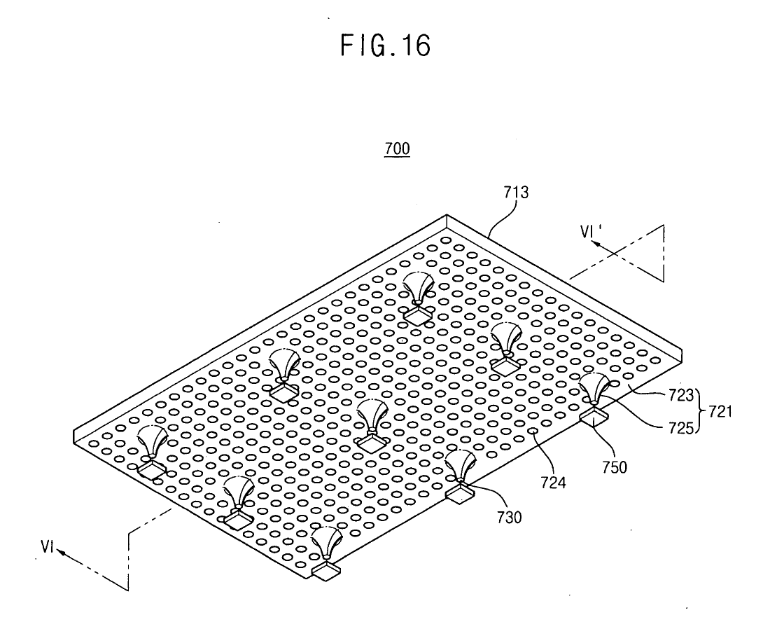

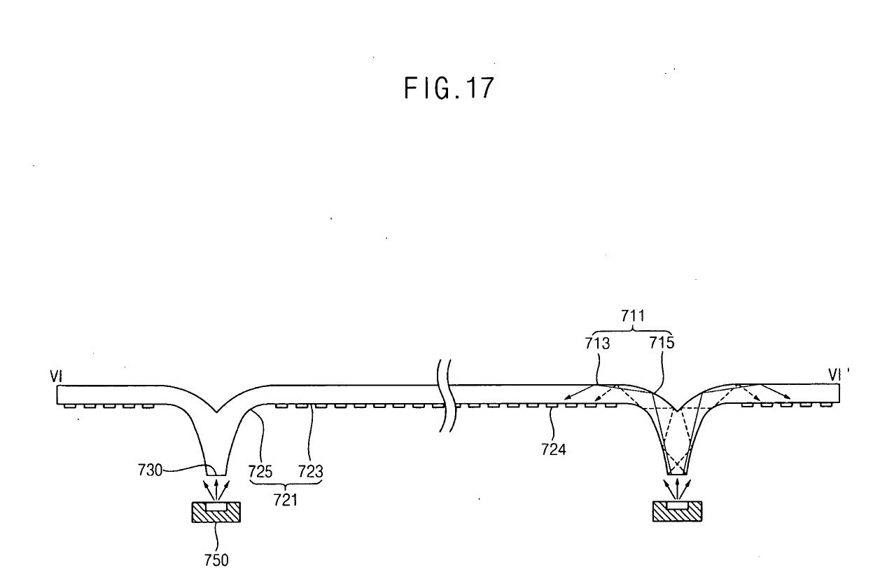

FIG. 16 is a perspective view illustrating a lower surface of a backlight assembly in accordance with another embodiment of the present invention. FIG. 17 is a cross-sectional view taken along the line VI-VI′ shown in FIG. 16.

Referring to FIGS. 16 and 17, the backlight assembly 700 includes a light guiding unit 710 and a light emitting diode 750.

The light guiding unit 710 of FIGS. 16 and 17 is substantially the same as the light guiding unit 400 shown in FIGS. 8 to 10. Thus, any redundant explanation concerning the above-described elements will be omitted.

A plurality of light incident surfaces 730 of the light guiding unit 710 is arranged in a matrix configuration. When red, green and blue light emitting diodes are arranged on the light incident surfaces 730, respectively, red light, green light and blue light do not mix. Thus, the red light, the green light and the blue lights may be displayed on a light exiting surface 713 to achieve mixing. However, in this case, the color uniformity of the light exiting the light guiding unit may be deteriorated. To avoid the deterioration of color uniformity, the light emitting diodes 750 include a plurality of white light emitting diodes that generate white light.

The white light incident on the light guiding unit 710 through the light incident surface 730 is refracted on the light incident surface 730, and is reflected from an upper guiding curved surface 715 and a lower guiding curved surface 725 through total internal reflection. In FIG. 17, the reflected light is guided between the light exiting surface 713 and an opposite surface 723 in a direction that is substantially orthogonal to the light exiting surface 713.

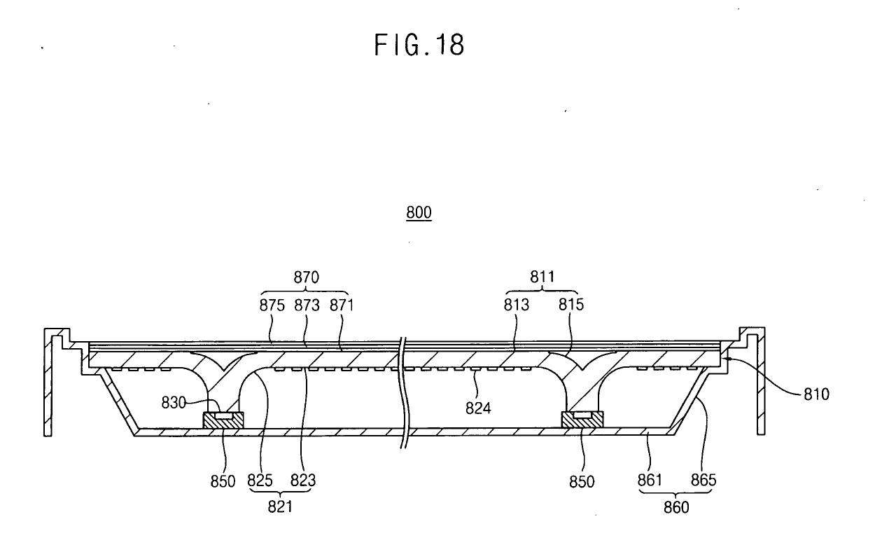

FIG. 18 is a cross-sectional view illustrating a backlight assembly in accordance with another embodiment of the present invention.

Referring to FIG. 18, the backlight assembly 800 includes a light guiding unit 810, a plurality of light emitting diodes 850 and a receiving container 860. The backlight assembly 800 of FIG. 18 is the same as the backlight assembly 500 shown in FIGS. 11 to 14. Thus, any redundant explanation concerning the above-described elements will be omitted.

The receiving container 860 includes a bottom plate 861 and a sidewall 865. The sidewall 865 is on a peripheral portion of the bottom plate 861. The light emitting diodes 850 are arranged on the bottom plate 861 in a first direction (shown in FIG. 1). For example, the light emitting diodes 850 are positioned on a plurality of light incident surfaces 830 of the light guiding unit 810 in two rows. The light emitting diodes 850 are on the light incident surfaces 830, respectively. A stepped portion is formed on an upper portion of the sidewall 865.

An end portion of the light guiding unit 810 is supported by the stepped portion. Each of the light incident surfaces 830 is on a flat portion of each of the light emitting diodes 850. In order to increase luminance, each of the light emitting diodes 850 may be spaced apart from each of the light incident surfaces 830 by a distance of no more than about 1 mm.

Red light, green light and blue light generated by the light emitting diodes 850 are guided to the light incident surfaces 830 in a normal direction of the bottom plate 861. The red light, the green light and the blue light incident on the light guiding unit 810 through the light incident surfaces 830 are mixed between the upper guiding curved surface 815 and the lower guiding curved surface 825 to form white light.

The portion of the red, green and blue lights that is not initially mixed to form the white light is reflected from the upper guiding curved surface 815 and the lower guiding curved surface 825 through total internal reflection to be guided between the upper guiding curved surface 815 and the lower guiding curved surface 825. In the course of traveling through the light guiding unit 810 by total internal reflection, any colored lights that were previously not mixed end up mixing.

A plurality of first prisms formed on the light incident surfaces 830 diffuses the red light, the green light and the blue light in the first direction to form the white light having improved color uniformity.

The backlight assembly 800 may further include optical sheets 870. The optical sheets 870 are on a light exiting surface 813 to improve optical characteristics of the white light exiting the light exiting surface 813. The optical sheets 870 include a diffusion sheet 871 and brightness enhancement sheets 873 and 875.

The diffusion sheet 871 increases the luminance uniformity of white light. The brightness enhancement sheets 873 and 875 are on the diffusion sheet 871 to increase luminance.

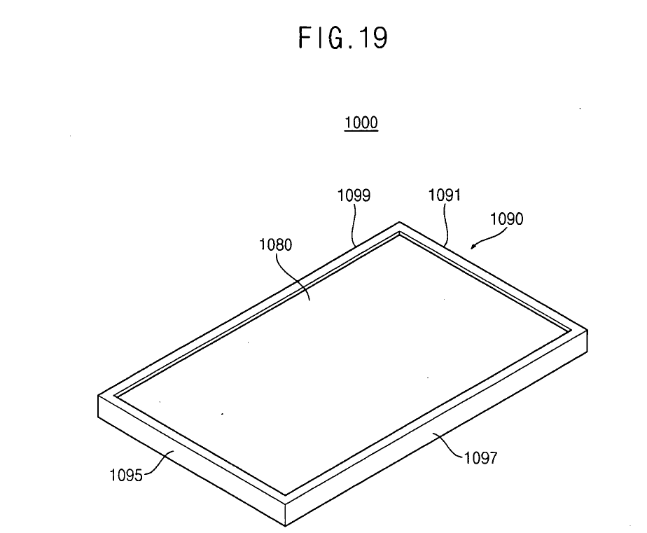

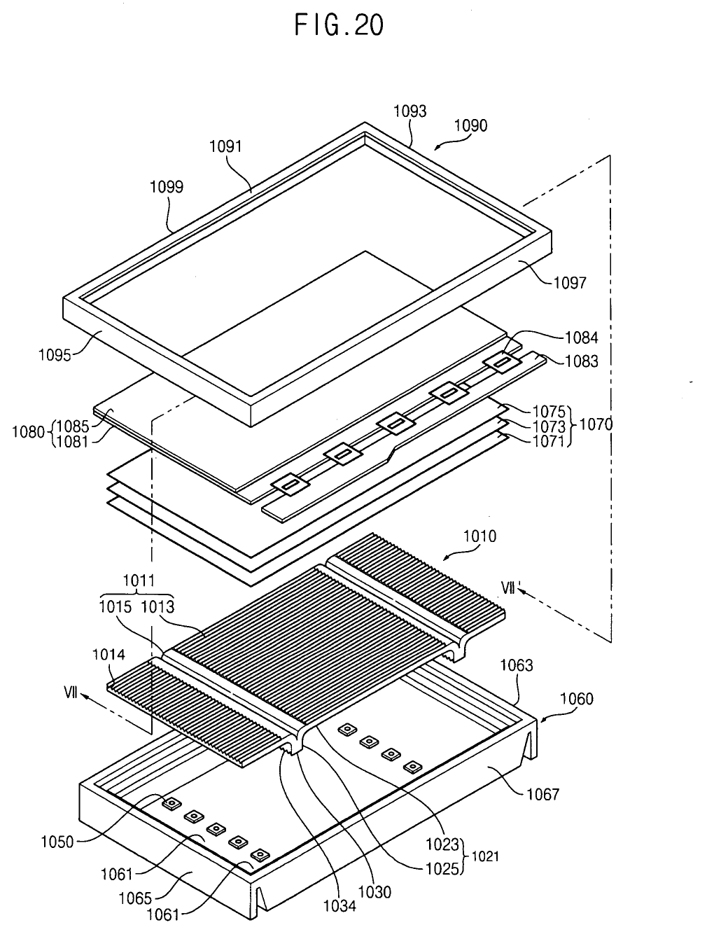

FIG. 19 is a perspective view illustrating a display device in accordance with another embodiment of the present invention. FIG. 20 is an exploded perspective view illustrating the display device shown in FIG. 19.

Referring to FIGS. 19 and 20, the display device 1000 includes a light guiding unit 1010, a light source and a display panel 1080. The light guiding unit 1010 and the light source of FIGS. 19 and 20 are substantially the same as the light guiding unit 500 and the light source shown in FIGS. 11 to 14. Thus, any redundant explanation concerning the above-described elements will be omitted.

The display device 1000 may further include a receiving container 1060 and optical sheets 1070.

The receiving container 1060 includes a bottom plate 1061, a first sidewall 1063, a second sidewall 1065, a third sidewall 1067 and a fourth sidewall 1069. The light source may include a plurality of light emitting diodes 1050. The light emitting diodes 1050 are arranged on the bottom plate 1061. The light emitting diodes 1050 may be arranged on light incident surfaces 1030 of the light guiding unit 1010 in two rows that are substantially parallel to a short side of the light guiding unit 1010.

The first, second, third and fourth sidewalls 1063, 1065, 1067 and 1069 protrude from sides of the bottom plate 1061 to form a receiving space. A stepped portion is formed on an upper portion of the first, second, third and fourth sidewalls 1063, 1065, 1067 and 1069 corresponding to an inner surface of the first, second, third and fourth sidewalls 1063, 1065, 1067 and 1069 to support an end portion of the light guiding unit 1010.

The optical sheets 1070 of FIGS. 19 and 20 are substantially the same as the optical sheets 870 shown in FIGS. 11 to 14. Thus, any redundant explanation concerning the above-described elements will be omitted.

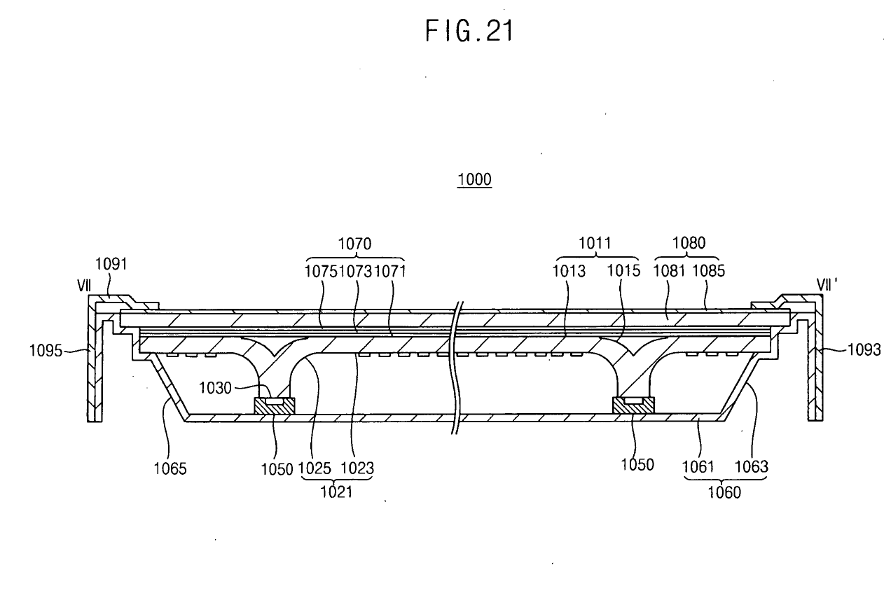

FIG. 21 is a cross-sectional view taken along the line VII-VII′ shown in FIG. 20.

Referring to FIG. 21, the display panel 1080 displays an image including image information based on the light exiting the optical sheets 1070. The display panel 1080 is on the optical sheets 1070, and is supported by the stepped portion. The display panel 1080 includes a first substrate 1081, a second substrate 1085 and a liquid crystal layer (not shown) between the two substrates 1081, 1085.

The first substrate 1081 includes a lower substrate and a switching element.

The lower substrate may be a glass substrate. A plurality of gate lines is formed on the lower substrate. A plurality of data lines is formed on the lower substrate in a direction that is perpendicular to the direction of the gate lines, and is electrically insulated from the gate lines. The gate and data lines define a plurality of pixel regions that are arranged in a matrix configuration.

For example, the switching element may include a thin film transistor (not shown), and is in each of the pixel regions. A source electrode of the thin film transistor is electrically connected to one of the data lines, and a gate electrode of the thin film transistor is electrically connected to one of the gate lines. In addition, a pixel electrode including a transparent conductive material is electrically connected to a drain electrode of the thin film transistor.

The second substrate 1085 is spaced apart from the first substrate 1081 by a predetermined distance, and faces the first substrate 1081. The second substrate 1085 includes an upper substrate and a plurality of color filters. The color filters correspond to the pixel regions, respectively, and are arranged in a matrix configuration on the upper substrate. The color filters include a red color filter, a green color filter and a blue color filter that transmit light of a predetermined color to display a color image. A common electrode is formed on substantially all of the upper substrate having the color filters. The common electrode corresponds to the pixel electrode.

When a gate driving signal is applied to the gate electrode of the thin film transistor, the thin film transistor is turned on so that a data driving signal is applied to the pixel electrode. Thus, an electric field is formed between the pixel electrode and the common electrode. Liquid crystals of the liquid crystal layer interposed between the first and second substrates 1081 and 1085 vary its arrangement in response to the electric field applied thereto, and thus transmission of the light incident on the display panel 1080 from the light emitting diodes 1050 through the optical sheets 1070 varies. Therefore, the display panel 1080 displays the image of a predetermined gray-scale.

The display panel 1080 may further include a printed circuit board 1083 (shown in FIG. 20) and a signal transmission film 1084 (shown in FIG. 20). The printed circuit board 1083 generates the gate driving signal and the data driving signal. The display panel 1080 is electrically connected to the printed circuit board 1083 through the signal transmission film 1084. A plurality of driving chips for controlling the gate driving signal and the data driving signal may be mounted on the signal transmission film 1084.

The display device 1000 may further include a top chassis 1090 (shown in FIG. 20) that is combined with the receiving container 1060. The top chassis 1090 includes an upper plate 1091 and a sidewall 1093. The upper plate 1091 of the top chassis 1090 may have an opening through which an effective display region of the display panel 1080 is exposed. The sidewall 1093 of the top chassis corresponds to the first, second, third and fourth sidewalls 1063, 1065, 1067 and 1069 of the receiving container 1060.

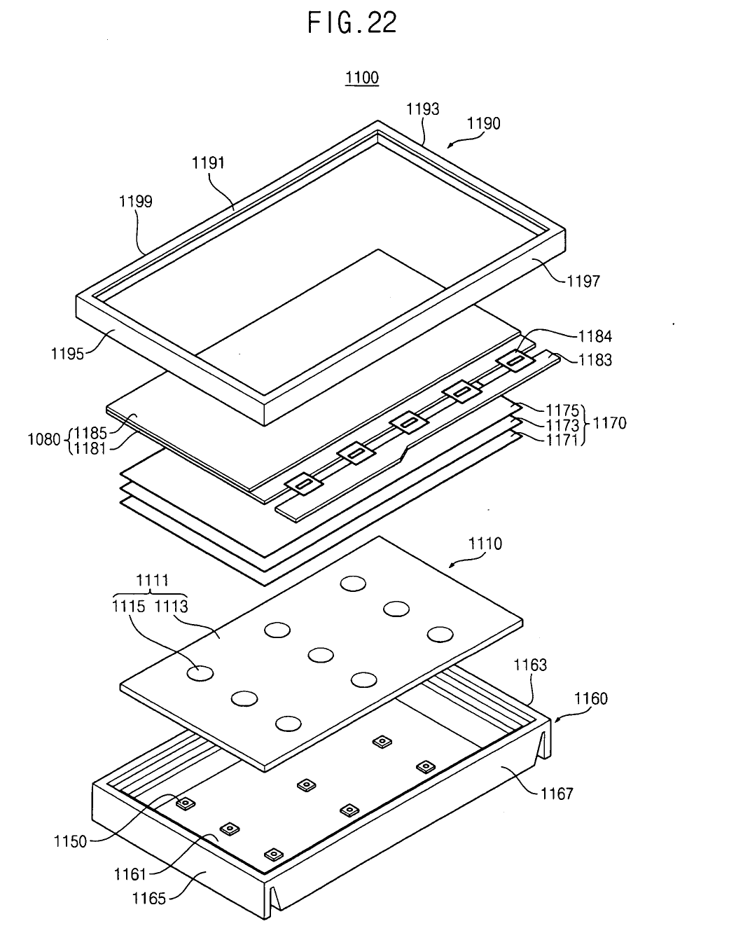

FIG. 22 is an exploded perspective view illustrating a display device in accordance with another embodiment of the present invention.

Referring to FIG. 22, the display device 1100 includes a light guiding unit 1110, a plurality of light emitting diodes 1150, a receiving container 1160, optical sheets 1170, a display panel 1180 and a top chassis 1190.

The display device 1100 of FIG. 22 is substantially the same as the display device 1000 shown in FIGS. 19 to 21. Thus, any redundant explanation concerning the above-described elements will be omitted.

The light guiding unit 1110 and the light emitting diodes 1150 of FIG. 22 are substantially the same as the light guiding unit 400 and the light emitting diodes 450 shown in FIGS. 8 to 10. Thus, any redundant explanation concerning the above-described elements will be omitted.

According to the present invention, the light generated from the light emitting diode is incident on the light guiding unit through a light incident surface. More specifically, light from the light emitting diode strikes the light incident surface from a direction that is substantially orthogonal to the light incident surface. The light incident on the light guiding unit is guided through the light guiding unit by the upper guiding curved surface and the lower guiding curved surface. The red, green and blue lights are guided to mix by the light guiding unit, thereby generating white light.

Therefore, the red, green and blue lights generated from the light emitting diodes are mixed by the light guiding unit. The distance between the light emitting diode and the display panel is decreased by the light guiding unit. Thus, the thickness of a direct illumination type backlight assembly is decreased.

In addition, the light guiding unit guides the lights generated from the light emitting diodes so that the light emitting diodes are not distributed on an entire surface of the light guiding unit. Thus, the luminance and the luminance uniformity of the backlight assembly are increased, although the light emitting diodes may be disposed only on the light incident surface.

Therefore, power consumption of the direct illumination type backlight assembly that supplies a large screen display panel is decreased.

This invention has been described with reference to exemplary embodiments. It is evident, however, that many alternative modifications and variations will be apparent to those skilled in the art in light of the foregoing description. Accordingly, the present invention includes all such alternative modifications and variations that fall within the spirit and scope of the appended claims.

What is claimed is:

1. A light guiding unit comprising:
a first surface including a light exiting surface and an upper guiding curved surface recessed with respect to the light exiting surface;
a second surface including an opposite surface that is substantially parallel to the light exiting surface and a lower guiding curved surface recessed on the opposite surface toward the first surface, the lower guiding curved surface positioned along the upper guiding curved surface; and
a light incident surface formed on an end portion of the lower guiding curved surface.

2. The light guiding unit of claim 1, further comprising a plurality of light incident surfaces extending in a first direction, and spaced apart from each other in a second direction that is substantially perpendicular to the first direction.

3. The light guiding unit of claim 1, wherein the light incident surface has a first optical pattern formed thereon to diffuse light in the first direction.

4. The light guiding unit of claim 2, wherein the first optical pattern comprises a plurality of first prisms extending in the second direction.

5. The light guiding unit of claim 1, wherein the opposite surface has a second optical pattern formed thereon to change a light path of the guided light.

6. The light guiding unit of claim 2, wherein the second optical pattern comprises a plurality of circular patterns including a plurality of second prisms extending in the first direction.

7. The light guiding unit of claim 1, wherein the light exiting surface has a third optical pattern formed thereon to guide the guided light in the first direction.

8. The light guiding unit of claim 2, wherein the third optical pattern comprises a plurality of third prisms extending in the second direction.

9. The light guiding unit of claim 1, further comprising a plurality of light incident surfaces arranged on the second surface in a matrix configuration.

10. The light guiding unit of claim 9, wherein the upper guiding curved surface has a substantially conical shape having a rounded apex.

11. The light guiding unit of claim 9, wherein the opposite surface has a plurality of circular patterns formed thereon.

12. The light guiding unit of claim 1, wherein the light incident surface is substantially parallel to the light exiting surface and the opposite surface.

13. The light guiding unit of claim 1, wherein the upper guiding curved surface is bent to have a first curvature, and the lower guiding curved surface is bent to have a second curvature that is greater than the first curvature.

14. The light guiding unit of claim 13, wherein each of the first curvature of the upper guiding curved surface and the second curvature of the lower guiding curved surface has either a variable curvature of an ellipsoid or a uniform curvature of a sphere.

15. The light guiding unit of claim 1, further comprising a liquid crystal film coupled to the light exiting surface to polarize light exiting the light exiting surface.

16. A backlight assembly comprising:
a light guiding unit including:
a first surface including a light exiting surface and an upper guiding curved surface recessed with respect to the light exiting surface;
a second surface including an opposite surface that is substantially parallel to the light exiting surface and a lower guiding curved surface recessed on the opposite surface toward the first surface, the lower guiding curved surface positioned along the upper guiding curved surface; and
a light incident surface formed on an end portion of the lower guiding curved surface; and
a light source optically coupled to the light incident surface.

17. The backlight assembly of claim 16, wherein the upper and lower guiding curved surfaces have profiles such that incident light travels between the light exiting surface and the opposite surface by total internal reflection off the upper and lower guiding curved surfaces.

18. The backlight assembly of claim 17, wherein the upper guiding curved surface is bent to have a first curvature, and the lower guiding curved surface is bent to have a second curvature that is greater than the first curvature.

19. The backlight assembly of claim 17, further comprising an air layer between the light incident surface and the light source.

20. The backlight assembly of claim 17, further comprising a connecting member connecting the light incident surface to the light source, wherein the connecting member comprises a transparent material.

21. The backlight assembly of claim 20, wherein the connecting member comprises silicone.

22. The backlight assembly of claim 16, further comprising a plurality of light incident surfaces having rod shapes arranged substantially parallel to each other, wherein the light source comprises a plurality of light emitting diodes arranged on the light incident surfaces.

23. The backlight assembly of claim 22, wherein the light emitting diodes comprise a red light emitting part generating red light, a green light emitting part generating green light and a blue light emitting part generating blue light, and
the light guiding unit guides the red, green and blue lights to mix so that white light is emitted from the light exiting surface.

24. The backlight assembly of claim 22, wherein the light source comprises a red light emitting diode generating red light, a green light emitting diode generating green light and a blue light emitting diode generating blue light, and
the light guiding unit that guides the red, green and blue lights to mix so that white light is emitted from the light exiting surface.

25. The backlight assembly of claim 22, wherein the light incident surface has a fourth optical pattern formed thereon to diffuse the light in the lengthwise direction of the light incident surfaces.

26. The backlight assembly of claim 22, wherein the opposite surface has a fifth optical pattern formed thereon to randomly diffuse the guided light.

27. The backlight assembly of claim 22, wherein the light exiting surface has a sixth optical pattern formed thereon to change a light path of the guided light.

28. The backlight assembly of claim 22, wherein the light source comprises a fluorescent lamp arranged along the length of the light incident surfaces.

29. The backlight assembly of claim 16, further comprising a plurality of light incident surfaces arranged in a matrix configuration.

30. The backlight assembly of claim 29, wherein the light source comprises a light emitting diode generating white light.

31. A backlight assembly comprising:
a light source generating light; and
a light guiding unit optically coupled to the light source, the light guiding unit having a substantially plate shape including a protruded portion that is protruded toward the light source.

32. The backlight assembly of claim 31, wherein the light guiding unit further comprises a recessed portion having substantially the same profile as the protruded portion.

33. The backlight assembly of claim 32, wherein the protruded portion further comprises a light incident surface formed on end portion of the protruded portion to face the light source.
